(19) United States
(12) Patent Application Publication
(10) Pub. No.: US 2009/0254229 A1
(43) Pub. Date: Oct. 8, 2009

(54) CONTROL DEVICE AND METHOD AND UNMANNED HELICOPTER HAVING THE SAME

(75) Inventor: Katsu Nakamura, Shizuoka-Ken (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: Yamaha Hatsudoki Kabushiki Kaisha, Shizuoka-ken (JP)

(21) Appl. No.: 11/910,425

(22) PCT Filed: Apr. 3, 2006
(86) PCT No.: PCT/JP2006/307041

§ 371 Date: Oct. 1, 2007

(30) Foreign Application Priority Data
Apr. 1, 2005 (JP) 2005-106216

(51) Int. Cl. G05D 1/00; G05D 1/08; G05B 13/02

(52) U.S. Cl. 701/2; 701/8; 701/1; 701/3; 700/28

(57) ABSTRACT

A control method comprises calculating a target value for at least one of a plurality of control parameters of a control target. The method also comprises performing feedback control of the control target in order for a value of a first of the control parameters to be set closer to its target value, and adjusting a target value of a second of the control parameters based at least in part on a deviation between the target value and a current value of at least one of the other control parameter.

### CROSS-REFERENCE TO RELATED APPLICATIONS

This application is a U.S. National Phase of the International Application No. PCT/JP2006/307041 filed Apr. 3, 2006 designating the U.S. and published in Japanese on Oct. 12, 2006 as WO 2006/107017, which claims priority of Japanese Patent Application No. 2005-106216, filed Apr. 1, 2005.

### BACKGROUND OF THE INVENTION

1. Field of the Invention

The present invention relates to a control device and method for an aircraft, and more particularly to a control device and method for an unmanned helicopter.

2. Description of the Related Art

Conventional unmanned helicopters are used for diffusing a chemical, such as an agrochemical substance, and for taking aerial photographs (as disclosed, for example, in Japanese Publication No. JP 2002-166893). When the unmanned helicopter is controlled, control items (or parameters) may include a heading direction, a roll angle, and a pitch angle of an airframe, a speed and an acceleration in the heading direction, a speed and an acceleration in the horizontal direction, a speed and an acceleration in the vertical direction, an altitude, and so forth. These control items are controlled by control systems independent of each other, for example, by feedback control based on the PID theory known in the art. Specifically, a manipulation amount corresponding to a command value having been specified in relation with each control item is input into the control system. The control system calculates a target value corresponding to the manipulation amount and inputs a control amount corresponding to the target value into the drive system for each control item. The result is fed back to the control amount, which is thereby set closer to the target value. Thus, feedback control is performed for each control item.

However, automatic control cannot be easily performed using the conventional control method described above. This is because the logical constitution of the control system becomes complex if a plurality of nonlinear control items irrelevant to each other is related to an operation of a controlling target thereof or if an environmental variation of such a controlling target is large in case that the control system is constituted in order for the operation of the controlling target to come closer to the target thereof.

For example, when the unmanned helicopter is flying with its nose pointed toward a destination, if a strong wind blows in the width direction (on a side of the helicopter), the operator can incline the airframe to increase the roll angle against the wind so that the airframe may not drift off course. In such a case, the lift force on the airframe decreases. If the roll angle is increased beyond a certain limit, the lift force decreases so much that the altitude of the airframe cannot be maintained. In such a case, even if the roll angle is solely controlled, the airframe cannot regain the roll angle and avoid the reduction in altitude.

### SUMMARY OF THE INVENTION

In view of the circumstances noted above, an aspect of the least one of the embodiments disclosed herein is to provide a control device and control method for a vehicle (e.g., a helicopter) to more easily perform automatic control of the vehicle. For example, in one embodiment, the control device can be used to monitor the operation of a helicopter and use the variance in a detected roll of the helicopter to automatically control another parameter (e.g., the heading of the helicopter).

In accordance with one aspect of the invention, a control method is provided comprising calculating a target value for at least one of a plurality of control parameters of a control target; performing feedback control of the control target in order for a value of a first of the control parameters to be set closer to its target value; and adjusting a target value of a second of the control parameters based at least in part on a deviation between the target value and a current value of the first control parameter.

In accordance with another aspect of the invention, a control device is provided comprising a target value calculation section configured to calculate a target value for at least on of a plurality of control parameters of a control target; a feedback control section configured to perform a feedback control of the control target so that a value of a first control parameter is set closer to its target value; and a characteristic usage determination section configured for adjusting a target value of a second of the control parameters based at least in part on a deviation between the target value and a current value of the first control parameter.

In accordance with still another aspect of the invention, an unmanned helicopter is provided comprising an airframe and a controller. The controller comprises a target value calculation section configured to calculate a target value of each of a plurality of control parameters of the unmanned helicopter; a feedback control section configured to perform a feedback control of the unmanned helicopter such that a value of a first of the control parameters is set closer to its target value; and a characteristic usage determination section configured to adjust a target value of a second of the control parameters based at least in part on a deviation between the target value and a current value of the first control parameter.

In accordance with still another aspect of the invention, a control device for controlling a control target is provided. The control device comprises means for calculating a target value for at least one of a plurality of control parameters of a control target, means for performing a feedback control of the control target to set a value of a first of the control parameters closer to its target value, and means for adjusting a target value for a second of the control parameters based at least in part on a deviation between the target value and a detected value for the first control parameter.

According to one aspect of the present invention, a deviation of a control item of a control target is fed back to other control items based on the deviation. Consequently, even if a plurality of nonlinear control items irrelevant to each other is related to an operation of the control target or even if an environmental variation of the control target is large, automatic control is more easily performed.

### BRIEF DESCRIPTION OF THE DRAWINGS

FIG. 1 shows a block diagram illustrating a constitution of a control device according to one embodiment.

FIG. 2 shows a block diagram illustrating a constitution of a control device according to one embodiment.

FIG. 3 shows a block diagram illustrating a constitution in case that the control device of the embodiment is applied to an unmanned helicopter.

FIG. 4A shows a schematic plan view of an unmanned helicopter receiving a crosswind.

FIG. 4B shows a schematic front view of an unmanned helicopter receiving a crosswind.

FIG. 4C shows a flow chart illustrating a first status determination procedure by a status determination section.

FIG. 4D shows a flow chart illustrating a second status determination procedure by the status determination section.

FIG. 5A shows a schematic plan view of an unmanned helicopter with its nose pointed to windward.

FIG. 5B shows a schematic front view of an unmanned helicopter with its nose pointed to windward.

FIG. 5C shows a flow chart illustrating a determination procedure by the characteristic usage determination section.

FIG. 5D shows a flow chart illustrating a calculation procedure of a manipulation correction value by a manipulation correction value calculation section.

### DETAILED DESCRIPTION OF THE PREFERRED EMBODIMENTS

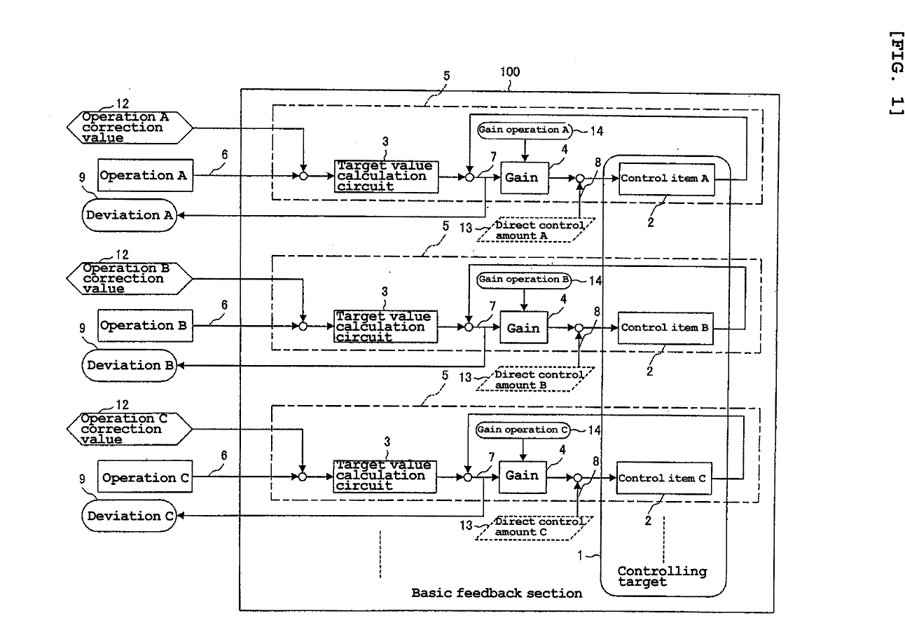

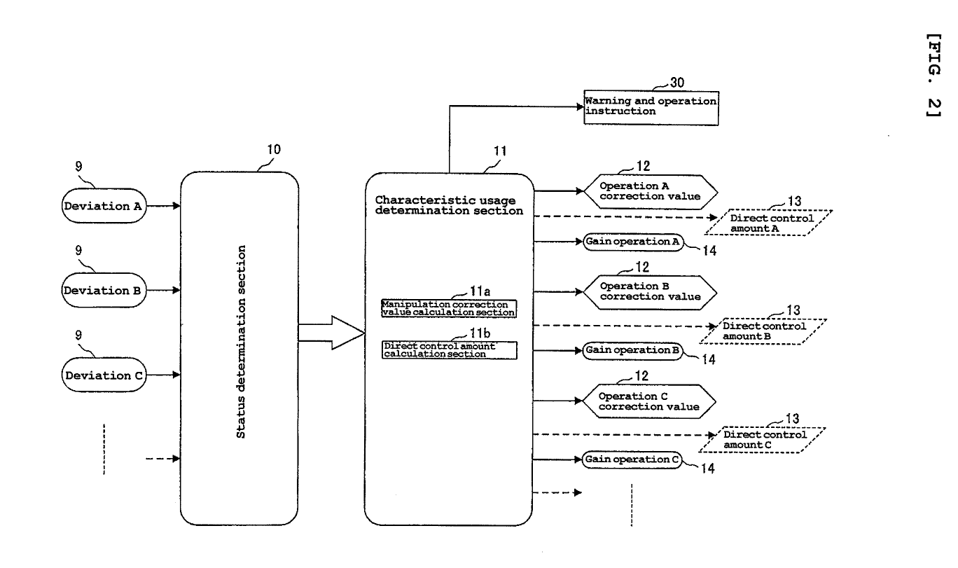

FIG. 1 and FIG. 2 show one embodiment of a control device that includes a basic feedback section 100, a status determination section 10, and a characteristic usage determination section 11.

The basic feedback section 100 can include a control target 1 having a plurality of control items 2 (e.g., control items A, B, C, . . . ) and a basic feedback control system 5 provided to each of the control items 2. The basic feedback control system 5 can include a target value calculation circuit 3 and a gain circuit 4.

As one example, an operation concerning the control item A will be described. When an operation A corresponding to a target operation of the control target is performed for the control item A, a manipulation amount signal 6 thereof is input into the basic feedback control system 5. The target value calculation circuit 3 calculates a control target value of the control item A according to the manipulation amount signal 6. The control amount corresponding to the target value is input to the drive system of the control item A (not shown) via the gain circuit 4 as a control amount signal 7, and thereby the drive system is operated. Thus, the control item A is controlled. The current value at the time or, in other words, a control result is fed back to the control amount. As a result, feedback control is performed in order for the value of the control item A to set closer to the target value.

In this example, the control amount may be directly input into the value of the control item A. A control amount by a control amount signal 8 based on a direct control amount 13 may be input to the control item A in place of a control amount by the control amount signal 7 from the target value calculation circuit 3 or may be input as a sum with the control amount by the control amount signal 7. As the control amount is directly input to the control item A as described above, various control can be performed.

An operation in the basic feedback control system 5 of the other control items B, C, . . . is the same as the operation of the control item A described above.

The operation described above obtains a deviation 9 (deviations A, B, C, . . . ) between a control amount from the target value calculation circuit 3 and a control result (a, b, c) in each basic feedback system 5. As shown in FIG. 2, each deviation 9 is entered into the status determination section 10, and a status of the control target corresponding to the deviation can be determined. This is for determining the status by identifying an operation of a control item known in advance such as a change in an attitude against a wind according to the degree of the deviation in relation to the status of the control target receiving a wind.

When the status is determined, the characteristic usage determination section 11 determines the possibility of usage of an operation characteristic to the control target related to a status such as, for example, an operation for reducing a wind pressure by at least one of a manipulation correction value calculation section 11a and a direct control amount calculation section 11b. In such a case, a control item operating corresponding to a status of the control target (the control item A, for example) and a control item operating to change the status of the control target (the control item B, for example) are treated as different control items during determination. Thus, the characteristic usage determination section 11 determines the possibility of usage of each control item based on a determination result of the status determination section 10.

The characteristic usage determination section 11 calculates a correction value 12 of the manipulation amount signal 6 shown in FIG. 1 with the manipulation correction value calculation section 11a. Further, the characteristic usage determination section 11 calculates the direct control amount 13 with the direct control amount calculation section 11b when a control amount is input directly via the control amount signal 8 (FIG. 1). The correction value 12 having been calculated corrects the manipulation amount signal 6 of the corresponding control item. The manipulation amount having been corrected is input to the target value calculation circuit 3.

As described above, the status of the control target is determined based on the deviation of a certain control item, and the target value of the control item is changed by correcting a manipulation amount of other control items based on a characteristic of the control target corresponding to the status. Accordingly, the deviation of the control item as the criterion for the determination of the status can be reduced. Further, if the correction value is used as a limitation of the manipulation amount in the same manner, the correction value can be utilized as a safety circuit for the control item.

A result of a determination by the status determination section 10 and the characteristic usage determination section 11 may be output, for example, by a display device, a buzzer, a lamp, and the like as a warning and operation 30. As a result, the user can understand the status of the control target more easily. For example, when there is a risk that an operation of the control target can be halted, attention of the user can be called by buzzing an alarm sound or displaying a warning display on the display device.

Similarly, a result of a determination by the status determination section 10 and the characteristic usage determination section 11 can be used as a safety measure for a hunting by a gain operation 14 for operating a gain 4 of the basic feedback section 100 or can change a status of an operation of the control target.

The control device of the illustrated embodiment can include a computer having a computing unit such as a CPU (Central Processing Unit), a storage device such as a memory and an HDD (Hard Disc Drive), an input device for detecting an input of information from an external device such as a keyboard, a mouse, a pointing device, a button, a touch panel, a jog shuttle, and a sliding pad, an interface device for transmitting various information over a communication line or via a broadcasting signal such as the Internet, a LAN (Local Area Network), a WAN (Wide Area Network), a telephone line, and a radio communication such as via a wireless connection (e.g., Rf communication), a computer having a display device such as a CRT (Cathode Ray Tube), an LCD (Liquid Crystal Display), and an FED (Field Emission Display), and a program installed on the computer. In other words, hardware and software cooperate so that the hardware resources described above may be controlled by the program, and therefore the basic feedback section 100, the status determination section 10, and the characteristic usage determination section 11 described above are realized. The program may be provided in a state in which the program is stored in a storage medium such as a flexible disk, a CD-ROM, and a DVD-ROM, a memory card.

An example in which the control device of the embodiment is applied to an unmanned helicopter will be described hereinafter. As shown in FIG. 3, the unmanned helicopter provided with the control device according to the embodiment includes a basic feedback section 200, the status determination section 10 (not shown), and the characteristic usage determination section 11 (not shown).

The basic feedback section 200 has control items of an airframe 14 of the unmanned helicopter as a control target including an airframe roll angle 2a, an airframe horizontal speed 2b, an airframe horizontal position 2c, an airframe yaw angular speed 2d, and an airframe azimuth 2e. A basic feedback control system is provided for each control item. The basic feedback control system is classified into two major classifications according to two manipulation amounts, which are an airframe axis lateral movement command and a nose movement command.

Basic feedback control systems according to the manipulation amount of the airframe axis lateral movement command are provided for the basic feedback control systems for the control items of the airframe roll angle 2a, the airframe horizontal speed 2b, and the airframe horizontal position 2c.

The basic feedback control system for the airframe roll angle 2a includes a target attitude calculation section 17 and a gain circuit 18. The target attitude calculation section 17 calculates a target attitude based on the target acceleration of the lateral movement calculated by a target acceleration calculation section 16 according to the airframe axis lateral movement command.

The basic feedback control system for the airframe horizontal speed 2b includes a target speed calculation section 19 and a gain circuit 20. The target speed calculation section 19 calculates a target speed of the lateral movement based on the target acceleration of the lateral movement calculated by the target acceleration calculation section 16.

The basic feedback control system for the airframe horizontal position 2c includes a target position calculation section 21 and a gain circuit 22. The target position calculation section 21 calculates a target position of the lateral movement based on the target speed of the lateral movement calculated by the target speed calculation section 19.

On the other hand, the basic feedback control systems according to the manipulation amount of the nose movement command are provided for the basic feedback control systems for the control items of an airframe yaw angular speed 2d and the airframe azimuth 2e.

The basic feedback control system for the airframe yaw angular speed 2d includes a target angular speed calculation section 23 and a gain circuit 24. The target angular speed calculation section 23 calculates a target angular speed in the direction of the movement of the nose based on the nose movement command.

The basic feedback control system for the airframe azimuth 2e includes a target direction calculation section 25 and a gain circuit 26. The target direction calculation section 25 calculates a target direction of the movement of the nose based on the target angular speed in the direction of the movement of the nose calculated by the target angular speed calculation section 23.

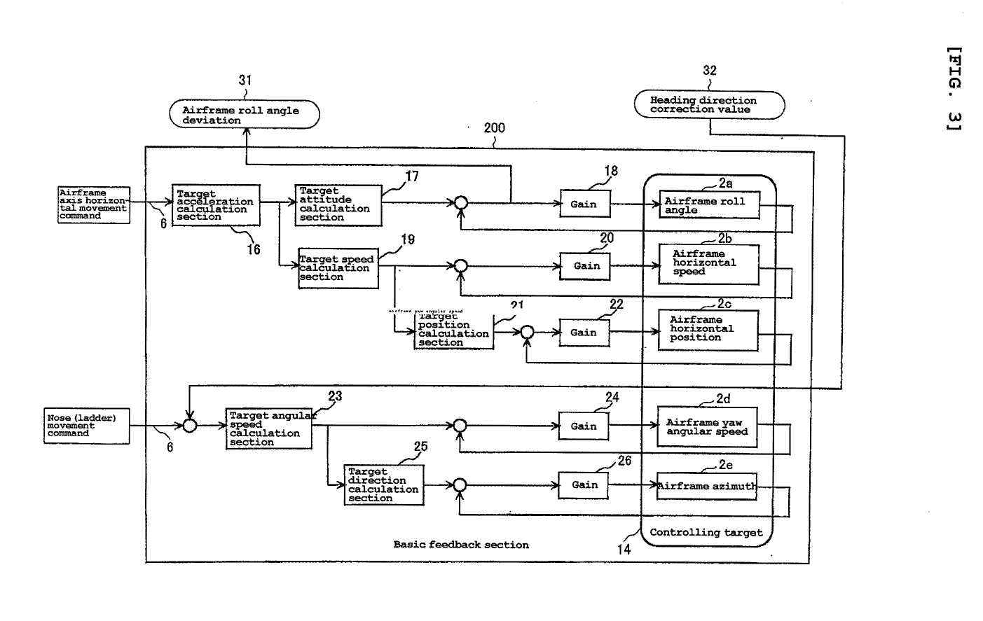

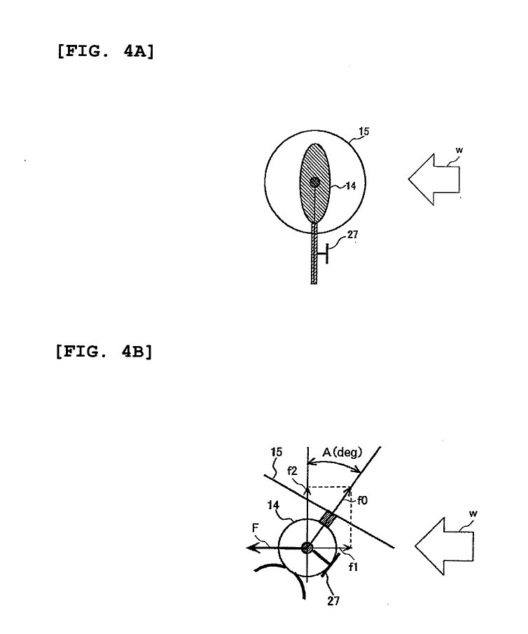

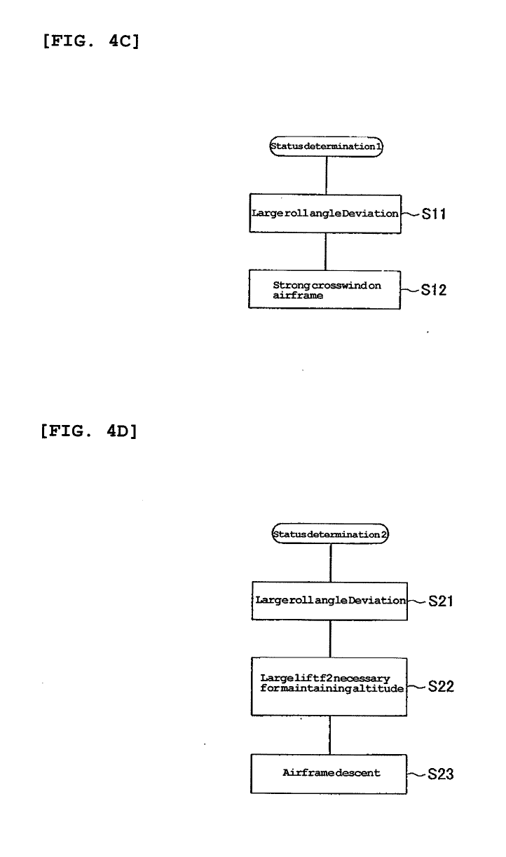

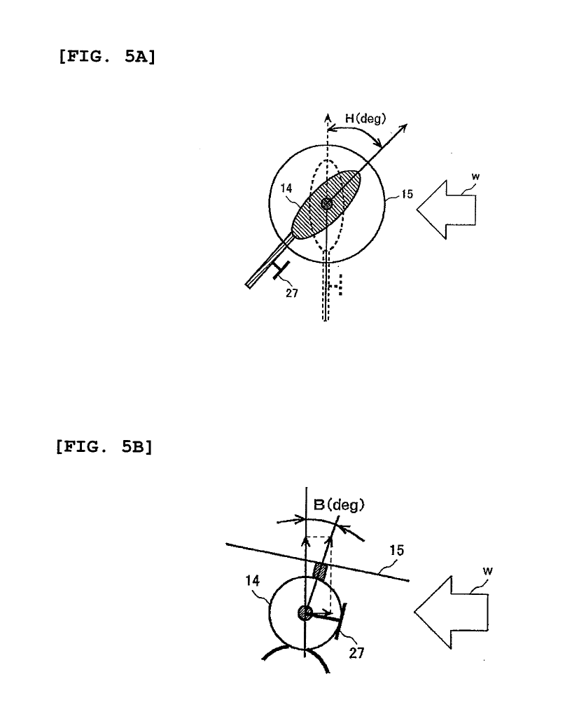

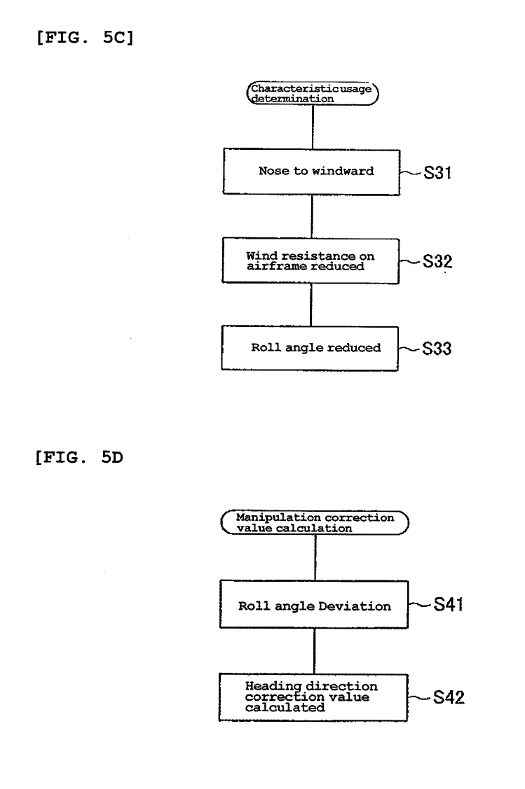

Control of the unmanned helicopter provided with the control device of the illustrated embodiment that receives a crosswind will be described hereinafter with reference to FIG. 4A to FIG. 4D and FIG. 5A to FIG. 5D.

As shown in FIG. 4A and FIG. 4B, when the airframe 14 as the target object receives a crosswind w, an airframe roll angle deviation 31 (shown in FIG. 3) is measured in the basic feedback control system for the control item of the airframe roll angle 2a. This deviation is input to the status determination section 10. As a result, a status of the wind is determined as described below.

The unmanned helicopter increases the roll angle of the airframe 14 to the windward by autonomous control in order to prevent the airframe 14 from drifting sideways and thus generates a propulsive force f1 in the width direction against a wind force F. As a result, a lift f2 in the vertical direction decreases according to the increased roll angle. The propulsive force f1 and the lift f2 are component forces of a propulsive force f0 given by a main rotor 15. Therefore, the status determination section 10 determines whether or not the deviation of the roll angle is larger than a predefined value (step S11) in a first procedure for judging the status shown in FIG. 4C in order to judge whether or not there is a status in which a wind is so strong that a countermeasure is necessary (step S12). The deviation of the roll angle is a difference between a roll angle A in a state in which the roll angle is increased against the wind and a target value (A=0°) of the roll angle in a state in which no wind is blowing. Consequently, if A>0°, it is determined that there is a status in which a wind is blowing.

During a second procedure for judging the status shown in FIG. 4D, if the deviation of the roll angle increases beyond a predefined value (step 21), the status determination section 10 determines that the lift f2 decreases so much that the altitude cannot be maintained (step S22) and further determines that there is a status in which the airframe will descend (step S23).

If the status is determined as described above, the characteristic usage determination section 11 starts the procedure for a characteristic usage determination shown in FIG. 5C. While the airframe 14 receives the wind, if the nose is turned to the windward (step S31), the projected area for receiving the wind is reduced. Accordingly, the wind blows along the airframe. Consequently, the resistance component of the wind on the airframe can be reduced (step S32). As a result, the roll angle against the wind is reduced (step S33). Specifically, when the heading direction, which is a control item different from the roll angle, is changed, the deviation of the roll angle is reduced. Thus, it is determined that a characteristic of a helicopter can be utilized. In this embodiment, the determination result by the status determination section 10 and the characteristic usage determination section 11 may be displayed on a display device or the like at a ground station of the unmanned helicopter. In this case, the user of the unmanned helicopter can recognize what determination is made in the unmanned helicopter.

As shown in FIG. 5A and FIG. 5B, the characteristic usage determination section 11 corrects the heading direction as much as H° by the manipulation correction value calculation section 11a. Thus, the deviation is reduced so that the roll angle (B) may be as large as the roll angle for securely maintaining the altitude of the airframe (step S41). The corrected amount H is calculated from the data on the deviation corresponding to the deviation of the roll angle (or, in other words, the strength of the crosswind)(step S42).

A heading direction correction value 32 (shown in FIG. 3) calculated by the manipulation correction value calculation section 11a is fed back to the basic feedback control system for the airframe yaw angular speed and the airframe azimuth different from the basic feedback control system for the airframe roll angle 2a. Thus, the command value of the nose movement command (the manipulation amount) is corrected. Specifically, when the nose movement command is issued from a tail rotor (a ladder) 27 based on the calculation result by the manipulation correction value calculation section 11a, the target angular speed calculation circuit 23 calculates a target angular speed for moving the direction of the nose. Consequently, a target direction is calculated by the target direction calculation section 25. Thus, feedback control of the control target for the airframe azimuth 2e is performed so that the heading direction of the airframe 14 of the unmanned helicopter may be oriented to the target direction. As a result, the deviation of the roll angle of the airframe can be reduced as described above.

As described above, according to the illustrated embodiment, the status of the control target can be understood from the deviation of one control item of the control target. Consequently, control is performed in order for the control target to be set closer to the target by feeding back the deviation to a different control item according to a characteristic in the relation between the status and the different control item. As a result, it is possible to create a program which links different control items with each other in a simple structure so that automatic control with high reliability may be realized. According to the control method, basic feedback control is performed for each control item to develop a pattern of control targets, and a nonlinear part such as, for example, an influence of a wind and the like to the unmanned helicopter can be recognized as a characteristic based on the deviation. Further, when the characteristic is fed back to another control item, it is possible to correspond to the nonlinear part and an environmental variation in a simple constitution. As for a stability of control, if basic stability is secured in the basic feedback control system each control item, when a deviation corresponding to a characteristic of a status is fed back for correcting a target value of the basic feedback system, it is not necessary to consider stability of the feedback control system for the control item. Consequently, control with high accuracy and high reliability can be achieved in a simple structure.

According to the illustrated embodiment, a manipulation amount corresponding to a goal of a control target is input to each control item, a target value of each control item is set according to the manipulation amount to control each control item, and a status of the control target is determined based on a deviation of a control result. Further, a manipulation amount of a control item different from the control item from which the deviation is obtained is corrected based on a characteristic in the relation between the status and each control item. As described above, it is possible to adjust the control target closer to the target by correcting the target value of a different control item corresponding to the status of the control target.

Further, according to the embodiment, a control amount for a correction based on a deviation can be directly input as a control amount of a control item the characteristic of which corresponds to a status. Therefore, because a change of a course or a change of an altitude can be appropriately performed as needed, it is possible to enhance diversity and stability of an operation.

Further, according to the embodiment, the operator can be informed of a status based on a deviation, for example, by an alarming display or the like. Consequently, a state of a control target can be recognized and monitored constantly and surely.

Further, according to the embodiment, it is possible to manipulate a control gain by using a status grasped based on a deviation. Consequently, a safety measure for a hunting accompanying with a change of an environment can be provided, and a status of an operation of a control target can be changed.

Further, according to the embodiment, while the unmanned helicopter is flown and controlled, when a roll angle of the airframe is changed, for example, by a wind affecting the airframe in an unpredictable and nonlinear relation or, in other words, when the roll angle (the airframe) is directed to the windward against the wind by autonomous control, it is possible to determine that there is a status in which the airframe is directed to receive wind blows. In addition to this, it is possible to change the heading direction to reduce the influence of the wind by reducing a projected area on which the wind blows. Thus, a characteristic specific to a helicopter can be utilized for flight control. If the influence of the wind is increased beyond a certain degree, the heading direction, which is a control item different from the roll angle as a control item from which the state of the wind is determined, is determined. As a result, the influence of the wind is reduced, and the reduction of the altitude of the airframe is prevented so that the flight may be continued in a steady state.

The embodiments disclosed above can be applied not only to an unmanned helicopter but also to a variety of devices having a plurality of control items such as, for example, electronic equipment, an aircraft, a watercraft, and a vehicle.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

1-6. (canceled)

7. A control method, comprising:
calculating a target value for at least one of a plurality of control parameters of a control target;
performing feedback control of the control target in order for a value of a first of the control parameters to be set closer to its target value; and
adjusting a target value of a second of the control parameters based at least in part on a deviation between the target value and a current value of the first control parameter.

8. The control method of claim 7, wherein adjusting comprises adjusting the target value of the second of the control parameters based at least in part on a deviation between the target value and a current value of each of the plurality of control parameters.

9. The control method according to claim 7, wherein the step of adjusting comprises:
determining a status of the control target based on the deviation, and
adjusting the target value of the second control parameter to reduce said deviation according to the determined status of the control target.

10. The control method of claim 9, wherein adjusting further comprises outputting the determined status of the control target based on the deviation.

11. The control method of claim 7, wherein adjusting comprises adjusting a control amount of the second control parameter instead of adjusting the target value of the second control parameter.

12. The control method of claim 7, wherein the control target is a vehicle.

13. The control method of claim 12, wherein the vehicle is a helicopter.

14. A control device, comprising:
a target value calculation section configured to calculate a target value for at least one of a plurality of control parameters of a control target;
a feedback control section configured to perform a feedback control of the control target so that a value of a first of the control parameters is set closer to its target value; and
a characteristic usage determination section configured to adjust a target value for a second of the control parameters based at least in part on a deviation between the target value and a current value for the first control parameter.

15. The control device of claim 14, wherein the characteristic usage determination section is configured to adjust the target value for the second of the control parameters based at least in part on a deviation between the target value and a current value of each of the plurality of control parameters.

16. The control device of claim 14, wherein the control target is a vehicle.

17. The control device of claim 16, wherein the vehicle is a helicopter.

18. An unmanned helicopter, comprising:
an airframe; and
a controller comprising
a target value calculation section configured to calculate a target value of each of a plurality of control parameters of an unmanned helicopter,
a feedback control section configured to perform feedback control of the unmanned helicopter such that a value of a first of the control parameters is set closer to its target value, and
a characteristic usage determination section configured to adjust a target value of a second of the control parameters based at least in part on a deviation between the target value and a current value of the first control parameter.

19. The unmanned helicopter of claim 18, wherein the control parameters comprise at least an airframe roll angle and an airframe azimuth.

20. The unmanned helicopter of claim 18, further comprising a communication interface configured to transmit information regarding an operating state of the unmanned helicopter to a ground station in communication with the helicopter.

21. The unmanned helicopter of claim 18, wherein the characteristic usage determination section is configured to adjust the target value of the second of the control parameters based at least in part on a deviation between the target value and a current value of each of the plurality of control parameters.

22. A control device for controlling a control target, comprising:
means for calculating a target value for at least one of a plurality of control parameters of a control target;
means for performing a feedback control of the control target to set a value of a first of the control parameters closer to its target value; and
means for adjusting a target value for a second of the control parameters based at least in part on a deviation between the target value and a detected value for the first control parameter.

23. The control device of claim 22, wherein the control target is a vehicle.

24. The control device of claim 23, wherein the vehicle is a helicopter.
